(19) United States
(12) Patent Application Publication
(10) Pub. No.: US 2014/0068279 A1
(43) Pub. Date: Mar. 6, 2014

(54) SYSTEMS, METHODS, AND MEDIUMS FOR SECURE INFORMATION ACCESS

(71) Applicants: Tarik Kurspahic, Washington, DC (US); Emir Mulabegovic, Sarajevo (BA); Muamer Rovcanin, Sarajevo (BA); Zaharije Pasalic, Sarajevo (BA)

(72) Inventors: Tarik Kurspahic, Washington, DC (US); Emir Mulabegovic, Sarajevo (BA); Muamer Rovcanin, Sarajevo (BA); Zaharije Pasalic, Sarajevo (BA)

(73) Assignee: Personal, Inc.

(21) Appl. No.: 14/116,245

(22) PCT Filed: May 7, 2012
(86) PCT No.: PCT/US2012/036782

§ 371 Date: Nov. 12, 2013

Related U.S. Application Data
(60) Provisional application No. 61/484,100, filed on May 9, 2011.

(51) Int. Cl. G06F 12/14

(52) U.S. Cl. CPC G06F 12/1408
USPC 713/193

(57) ABSTRACT

Systems, methods, and tangible computer-readable storage mediums for secure access to information are presented. More particularly, embodiments relate to encrypting at least part of the information using an information-specific key or a key symmetric to the information-specific key; encrypting the information-specific key using a first public key; encrypting a first private key; and storing in memory the encrypted information, encrypted first private key, and the encrypted information-specific key. Some further embodiments include: decrypting the first private key; decrypting the information-specific key using the first private key; and decrypting at least part of the information using the information-specific key.

### CROSS-REFERENCE TO RELATED APPLICATION

This application claims the benefit of U.S. Provisional Application 61/484,100, filed May 9, 2011 and entitled “PERSONAL SECURE GRANT ACCESS”, the entirety of which is hereby incorporated by reference.

### FIELD OF THE APPLICATION

The present application relates to the field of secure storage, transfer and retrieval of information.

### SUMMARY

Aspects of the systems, methods, and tangible, computer-readable storage media as well as computer programs for providing secure access to information are described herein. Embodiments of the present invention employ a system of encryption to provide a high level of information security for system users, while increasing the efficiency and speed of underlying computer systems, resulting in a tangible and concrete technical benefit to a system operator.

In one specific aspect of the present application, a system for the storage and communication of confidential, personal information is described. The system allows users to store and manage confidential information on the system. In one particular embodiment, a unit of confidential information is received from a user. The unit of confidential information may be, for example, a file, and may require significant storage space. In some embodiments, the unit of confidential information can be encrypted using an encryption key that is specific to that unit of confidential information. The information-specific key is itself encrypted using an asymmetric encryption algorithm having a public key, where the public key is assigned to the user (owner of the information). In one embodiment, only encrypted versions of the information-specific key are non-transiently stored by the system. The encrypted information-specific key can be decrypted by a private key assigned to the user-owner of the information. The private key is in turn encrypted using a password provided by the user-owner, and the encrypted private key is stored. In some embodiments, only a password-encrypted private key is non-transiently stored by the system. In one embodiment, the password is not stored by the system in a non-transient fashion, but is provided by the user-owner (for example, over the Internet via a secure socket connection) as needed. In some embodiments, a hash of the password is stored, in order to verify that any entered password is correct. If access to the unit of confidential information is to be provided to another user, the user-owner can enter the correct password, which can be verified against a hash. The password is used to decrypt the user-owner's private key, which can be used to decrypt the information-specific key. The information-specific key can be re-encrypted using the public key of a second user designated by the user-owner, and the re-encrypted information-specific key can be transferred to the second user. In one embodiment, only a single copy of the encrypted unit of confidential information is non-transiently maintained. The system avoids transfer of the unit of confidential information itself to the second user, and avoids the necessity to re-encrypt and re-distribute the entire unit of confidential information should, for example, changes be made to it. Furthermore, the information-specific key is not, in this embodiment, non-transiently stored in unencrypted form, nor are the private keys necessary to decrypt the information-specific key available without access to the password of a user having access. The system of these embodiments thus allows highly efficient transfer and access to information, without itself having access to the content of that information, except when access is commanded by an authorized user.

Therefore, one aspect of the present application is a method for providing secure access to information. The method includes: encrypting at least part of the information using an information-specific key or a key symmetric to the information-specific key; encrypting the information-specific key using a first public key; encrypting a first private key; and storing in memory the encrypted information, encrypted first private key, and the encrypted information-specific key. In some further embodiments, encrypting the first private key includes using a password to encrypt the first private key, where the password itself is used as a key or used to derive a key.

In some embodiments, the method further includes decrypting the first private key; decrypting the information-specific key using the first private key; and decrypting at least part of the information using the information-specific key. In some further embodiments, decrypting the first private key includes using a password to decrypt the first private key.

According to some embodiments, the method further includes decrypting the first private key; decrypting the information-specific key using the first private key; and encrypting the information-specific key using a second public key. In some further embodiments, the method further includes decrypting the information-specific key using a second private key and decrypting at least part of the information using the information-specific key. In other further embodiments, the method further includes verifying permission to access information. In some further embodiments, decrypting the first private key includes using a password to decrypt the first private key.

Some embodiments of the method further include verifying that a hash of a password matches a stored password hash.

Some embodiments of the method further include limiting access to the information to at least one of creating, reading, updating, deleting, or sharing.

Another aspect of the present invention is a computer system for providing secure access to information. The computer system includes: memory hardware storing program instructions, and one or more processors in data communication with the memory hardware and configured to execute the program instructions, and upon execution the program instructions cause the one or more processors to perform operations, including: encrypting at least part of the information using an information-specific key or a key symmetric to the information-specific key; encrypting the information-specific key using a first public key; encrypting a first private key; and storing in memory the encrypted information, encrypted first private key, and the encrypted information-specific key. In some further embodiments, encrypting the first private key includes using a password to encrypt the first private key.

In some embodiments, the operations further include decrypting the first private key; decrypting the information-specific key using the first private key; and decrypting at least part of the information using the information-specific key. In some further embodiments, decrypting the first private key includes using a password to decrypt the first private key.

According to some embodiments, the operations further include decrypting the first private key; decrypting the information-specific key using the first private key; and encrypting the information-specific key using a second public key. In some further embodiments, the computer system further includes decrypting the information-specific key using a second private key and decrypting at least part of the information using the information-specific key. In other further embodiments, the computer system further includes verifying permission to access information. In some further embodiments, decrypting the first private key includes using a password to decrypt the first private key.

Some embodiments of the computer system operations further include verifying that a hash of a password matches a stored password hash.

Some embodiments of the computer system operations further include limiting access to the information to at least one of creating, reading, updating, deleting, or sharing.

Yet another aspect of the present application is a tangible computer-readable storage medium and a computer program for providing secure access to information. The tangible computer-readable storage medium has instructions encoded thereon. Likewise, the computer program comprises instructions. The instructions, when processed by a processing circuit, perform the following: encrypting at least part of the information using an information-specific key or a key symmetric to the information-specific key; encrypting the information-specific key using a first public key; encrypting a first private key; and storing in memory the encrypted information, encrypted first private key, and the encrypted information-specific key. In some further embodiments, encrypting the first private key includes using a password to encrypt the first private key.

In some embodiments, the tangible computer-readable storage medium further includes instructions for decrypting the first private key; decrypting the information-specific key using the first private key; and decrypting at least part of the information using the information-specific key. In some further embodiments, decrypting the first private key includes using a password to decrypt the first private key.

According to some embodiments, the tangible computer-readable storage medium further includes instructions for decrypting the first private key; decrypting the information-specific key using the first private key; and encrypting the information-specific key using a second public key. In some further embodiments, the tangible computer-readable storage medium further includes instructions for decrypting the information-specific key using a second private key and decrypting at least part of the information using the information-specific key. In other further embodiments, the tangible computer-readable storage medium further includes instructions for verifying permission to access information. In some further embodiments, decrypting the first private key includes instructions for using a password to decrypt the first private key.

Some embodiments of the tangible computer-readable storage medium further include instructions for verifying that a hash of a password matches a stored password hash.

Some embodiments of the tangible computer-readable storage medium further include limiting access to the information to at least one of creating, reading, updating, deleting, or sharing.

### BRIEF DESCRIPTION OF THE DRAWINGS

FIG. 1 is a schematic diagram of a system, according to an exemplary embodiment;

FIG. 2 illustrates a computer system for implementing a method of providing secure access to information, according to an exemplary embodiment;

FIG. 3 is a flowchart of a method according to an exemplary embodiment, such that a user submits information and access to the information is granted to other(s);

FIG. 4 is a flowchart of a method according to an exemplary embodiment, such that a user submits information that is encrypted and stored;

FIG. 5 is a flowchart of a method according to an exemplary embodiment, such that stored encrypted information is made available to the user that submitted the information;

FIG. 6 is a flowchart of a method according to an exemplary embodiment, such that access to encrypted information is provided to another user; and

FIG. 7 is a flowchart of a method according to an exemplary embodiment, such that information is made available to a user that has been granted access by someone else.

### DETAILED DESCRIPTION OF THE PREFERRED EMBODIMENTS

The systems, methods, and tangible, computer-readable storage medium and computer programs of the present invention provide a way of providing access to information. Such methods are envisioned to be carried out on a computer system, which may comprise one or more integrated circuit or other processors that may be programmable or special-purpose devices. The system can comprise memory which may be one or more devices, which may be persistent or non-persistent, such as dynamic or static random access memories, flash memories, electronically erasable programmable memories, or the like, having instructions embedded therein, such that if executed by a programmable device, the instructions will carry out methods as described herein to form systems and devices having functions as described herein. When carried out as described herein, the systems, methods and tangible, computer-readable storage media and computer programs of the present application increase the efficiency and speed and security of the underlying computer system, resulting in a tangible and concrete technical benefit to a system operator, while providing a high level of information security to a user.

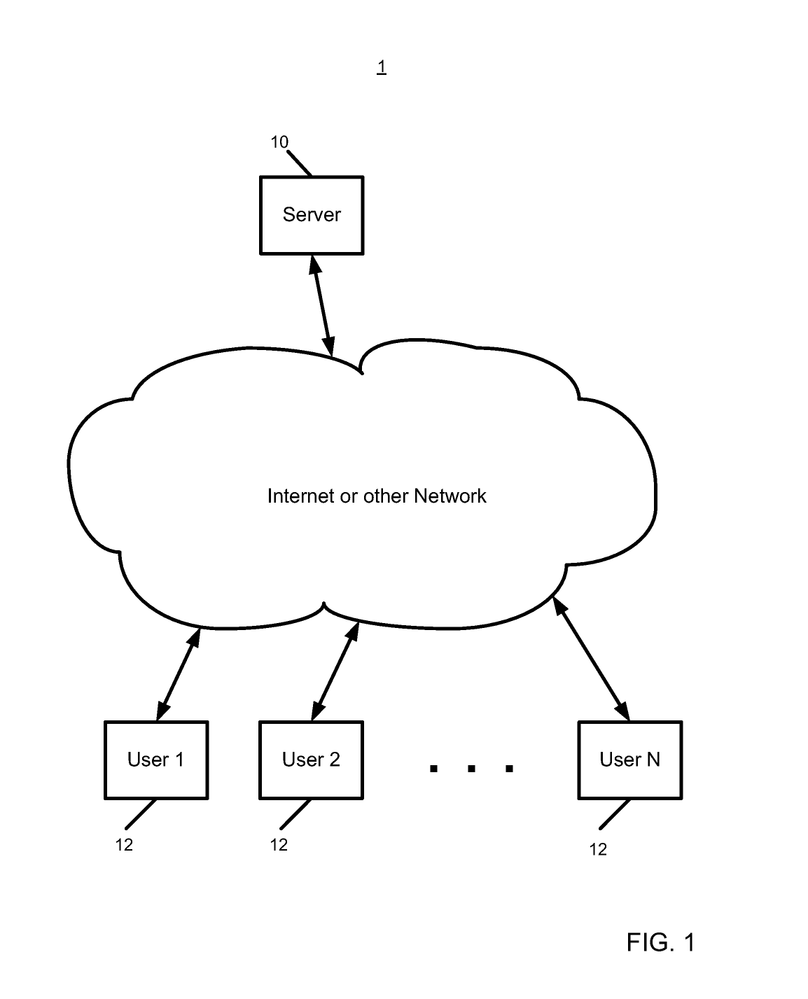

FIG. 1 illustrates a system according to some embodiments of the present invention. As shown in FIG. 1, an exemplary networked system 1 for implementing process(es) according to embodiments of the present invention may include, but is not limited to, a general-purpose computing device 10 that interacts with users through a network, such as, but not limited to, the Internet. The computing device 10 may be a server 10 that communicates over a network with user devices 12, which include, but are not limited to, general-purpose computers, special-purpose computers, tablet computers, smartphones, PDAs, and the like. User devices 12 may communicate with a server 10 through a web site. The user devices 12 may be mobile devices and the web site may be a mobile web site, intended to be accessed through mobile devices. The user devices 12 may communicate with a server 10 through one or more applications comprising computer-executable instructions. Alternative embodiments may not involve a network at all, and may instead be implemented on a standalone device 10 used by the user(s).

The server 10 may be implemented as a network of computer processors. In some implementations, the server may be multiple servers, mainframe computers, networked computers, a processor-based device, or a similar type of system or device. In some implementations, the server 10 may be a server farm or data center. The server 10 may receive connections through a load-balancing server or servers. In some implementations, a task may be divided among multiple servers 10 that are working together cooperatively.

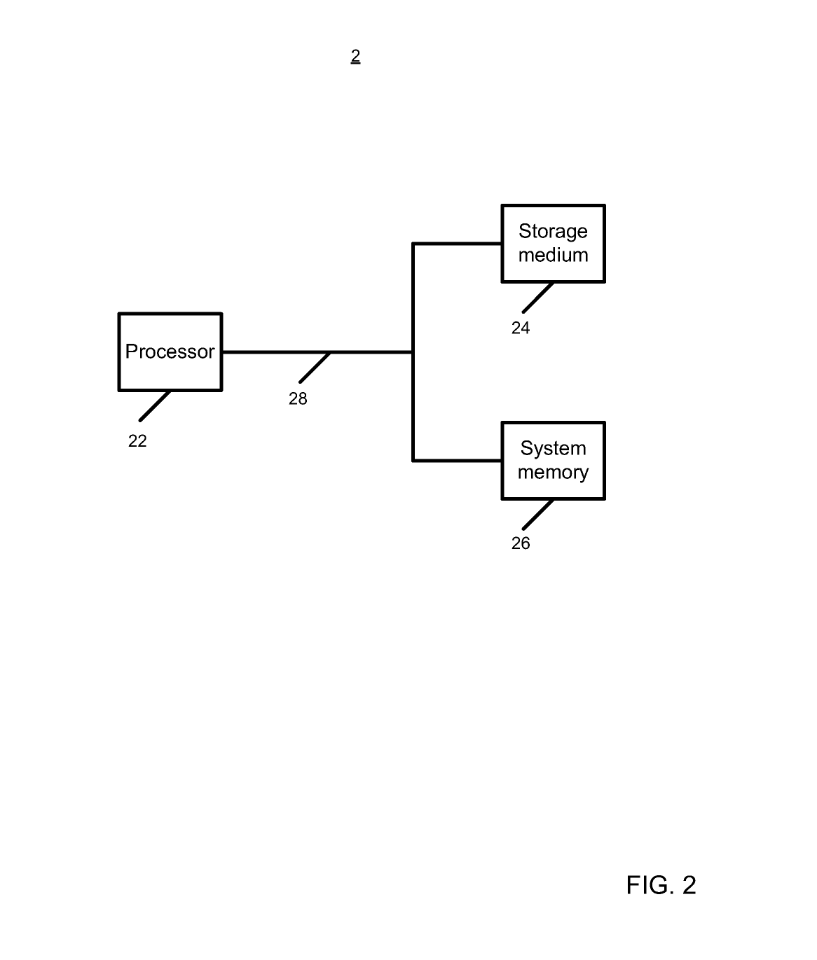

FIG. 2 illustrates a system according to some embodiments of the present invention. As shown in FIG. 2, an exemplary system 2 for implementing the method(s) discussed includes (but is not limited to) a general-purpose computing device in the form of a conventional computer, including a processing unit 22 or processor, a system memory 26, and a system bus 28 that couples various system components including the system memory 26 to the processing unit 22. The system memory 26 may include one or more suitable memory devices such as, but not limited to, RAM. The computer may include a storage medium 24, such as, but not limited to, a solid state storage device and/or a magnetic hard disk drive (HDD) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. A storage medium 24 may be external to the computer, such as external drive(s), external server(s) containing database(s), or the like. The drives and their associated computer-readable media may provide non-transient, non-volatile storage of computer-executable instructions, data structures, program modules, and other data for the computer to function in the manner described herein. Various embodiments employing software and/or Web implementations are accomplished with standard programming techniques.

According to various embodiments, computer-executable instructions may encode a process of securely sharing access to information. The instructions may be executable as a standalone, computer-executable program, as multiple programs, may be executable as a script that is executable by another program, or the like.

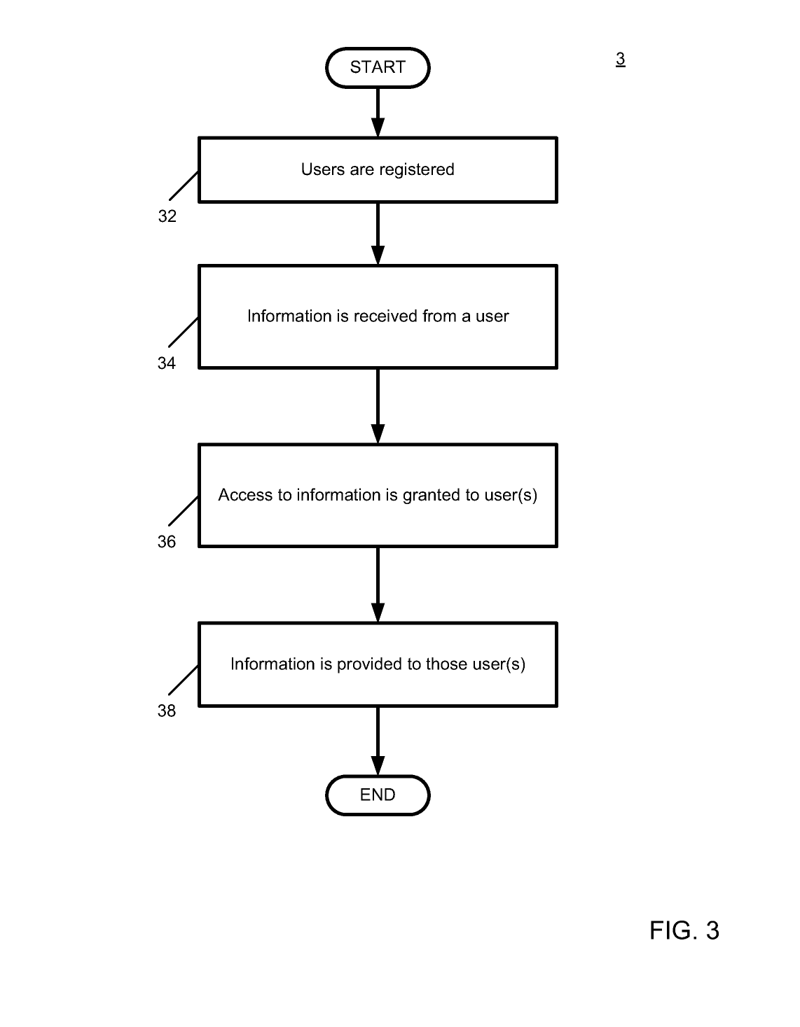

With reference to FIG. 3, a method of submitting information and allowing access to it according to various embodiments is implemented by a computer system 2 (FIG. 2) according to a process 3. A processor 22 may execute instructions that instruct information to be saved to a storage medium 24 (FIG. 2).

In some embodiments, in step 32, users may register in order to create an account. A “user”, as used herein, may be a single user or a group of users, and may apply to human user, a machine, a virtual machine, or a combination of any number of those. Users may provide information about the users themselves, their companies, or the like. In preferred embodiments, the user is the owner of the information. The user may provide a key pair containing a public key and a private key. Alternatively, the system 2 may provide a key pair. The user may provide a unique username, email address, a fingerprint, or an equivalent. Some or all information provided or created for the user or the user's account may be stored in a storage medium 24.

The user may provide a password or equivalent. In some embodiments, a password may be created for the user. The password may be a combination of letters, digits, and/or special characters with a minimum number of characters, such as eight. The password may be provided by the user in plain text. The password may be transmitted to the server 10 in plain text or it may be encrypted for transport.

In some embodiments, a hash of the user's password or equivalent may be stored in a storage medium 24 (FIG. 2). A password hash may be a one-way encryption or transformation of a password. Examples of hash algorithms include SHA-2, the still under development SHA-3, WHIRLPOOL and others. The password hash may be augmented by a salt value or other value. This has the benefit of increasing the cryptographic strength of the hash. The password or equivalent may be stored, or it may not be stored if the hash is stored instead. In some embodiments, when a user logs in, the user provides a password, and a hash may be taken over the provided password. This hash may be compared to a stored hash. If they are the same, the log-in may succeed. If they are not the same, the log-in may fail.

Non-transiently storing the hash of a password, but not the password itself, is beneficial because it maintains security while reducing the likelihood that information can be accessed if a hash is stolen. If an unencrypted password is found by an intruder to server 10, then it can be used to log in to the user's account, so that the intruder has access to everything accessible by the account. However, if the hash is found by the intruder, then it likely cannot be used to successfully log in. (Attempting to log in using the hash would cause a new hash to be taken over the original one, which would be highly unlikely to match the stored, original hash.)

In step 34, information may be received from one or more users. Information may be transmitted from one or more user devices 12 and received by one or more servers 10 (FIG. 1). Information may be divided into components referred to herein as “gems”. The information for a single gem may be submitted by multiple users. Information for a single gem may be submitted in portions, over time, or all at once. Information contained in a gem may be updated, changed, deleted, combined with other gem(s), or the like. A gem may include a group of structured data fields. A gem may additionally include metadata or other data. The data fields of a gem may be specified using a markup language (such as XML), individual submissions of text, or any manner of text submission.

For example, a gem may include information such as a list of people invited to a private dinner party. In another example, a gem may include estimated values of vehicles for sale or components necessary for the assembly of a vehicle.

In step 36, access to the information may be granted to one or more other users. Alternatively, no access may be granted to the information. As another alternative, only the user that had submitted the information may be granted access to it.

In step 38, information may provided to user(s) (if any) that have access to it. In some embodiments, if no information is requested by a user provided access, no information may be provided.

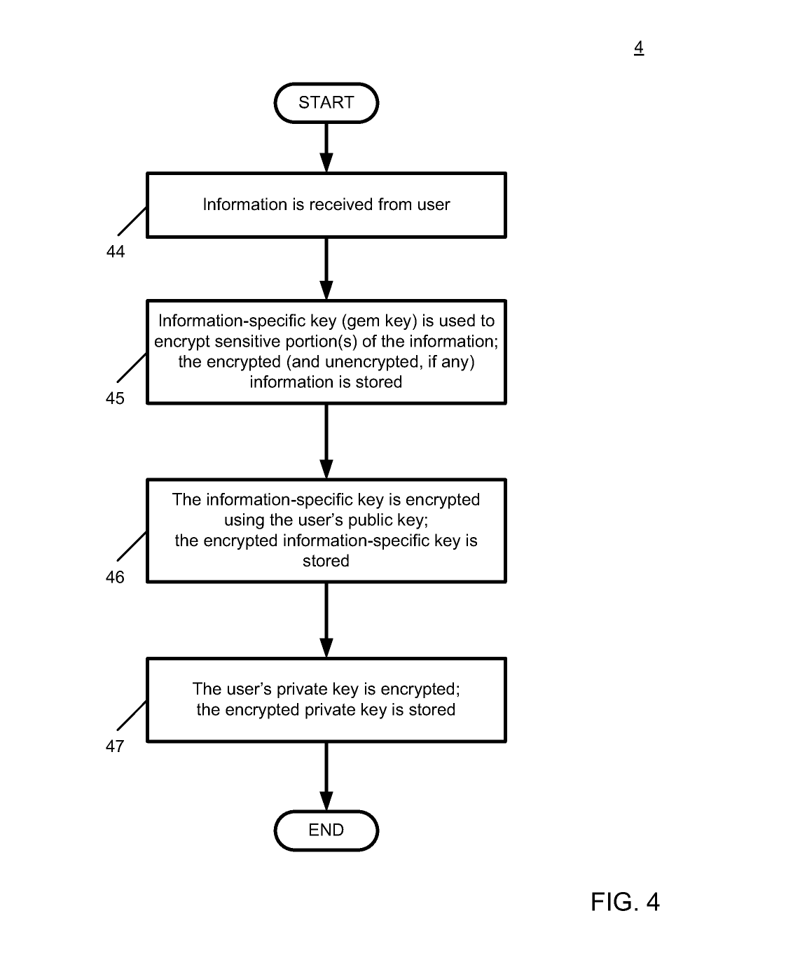

With reference to FIG. 4, a method of submitting, encrypting, and storing information according to various embodiments is implemented by a computer system 2 (FIG. 2) according to a process 4. Step 44 of process 4 may be the same as step 34 of process 3 in FIG. 3.

Still referring to FIG. 4, in step 45, an information-specific key may be used to encrypt sensitive portion(s) of the information. In the present application, an “information-specific key” is an encryption key that is separately provided for a unit of information. The unit of information may be encrypted in full, in part, or not at all. The encrypted portions and non-encrypted (non-sensitive) portions of the information may be stored in a storage medium 24. Information that is not stored may be discarded.

The information-specific key may correspond to one or more gems. That is, the information-specific key may be used for encrypting the sensitive portion(s) of a specific gem or gems and not other gems. The information-specific key may be stored in the metadata of a gem, preferably in encrypted form.

The information-specific key may be used for symmetric encryption. The same information-specific key may be used to both encrypt and decrypt the same data. Alternatively, an information-specific key may be used to encrypt data and a symmetric or trivially related key may be used to decrypt the same data (or vice versa). This simplifies the process because it avoids the need of having to store, encrypt, decrypt, manage, and use one key for encryption and a different key for decryption. Symmetric encryption algorithms may include, but are not limited to, AES (such as AES 256 bit), Blowfish, DES, Triple DES, Serpent, Twofish, and the like.

In step 46, the information-specific key may be encrypted using a public key. The public key may be from the key pair of the user providing the information to the server 10. The encrypted information-specific key and/or the public key may be stored in a storage medium 24. The encrypted information-specific key may be stored within the metadata of one or more corresponding gems. The public key may be stored in unencrypted form. The unencrypted form of the information-specific key may be discarded and not permanently stored.

Key pair(s) may be used for asymmetric encryption. A key pair may include a public key and a private key, which may be different, but mathematically related, keys. The public key may be used for encryption such that only the holder of the private key may decrypt what was encrypted. This is beneficial because it allows encryption and decryption without requiring a secure exchange of keys. Asymmetric encryption algorithms may include, but are not limited to, RSA (such as RSA 2048-bit), ElGamal, Diffie-Hellman, Cramer-Shoup, and the like.

In step 47, a private key may be encrypted. The private key may be from the key pair of the user providing the information to the server 10 (FIG. 1). The encrypted private key may be stored in a storage medium 24 (FIG. 2). The unencrypted form of the private key may be discarded and not permanently stored. In some embodiments, the private key may be encrypted using a password. The encryption may be symmetric encryption. The password used for encrypting may be the password of the user providing the information to the server 10 (FIG. 1).

A hash of a password may be stored (if not previously stored). The hash may be stored at any time once the password is provided. For example, the hash may be stored when the user registers for an account, when the user changes the password, when the hash is used for encryption, or the like. The password may be discarded and not permanently stored.

An advantage of the encryption described in, for example, method 4, is that system administrators of the server 10 or intruders into the server 10 would not have access to the unencrypted form of the information, nor would they be able to obtain access without having an appropriate user password (other than by breaking or working around the encryption). Thus, the information is kept highly secure, even secure against those administering the system.

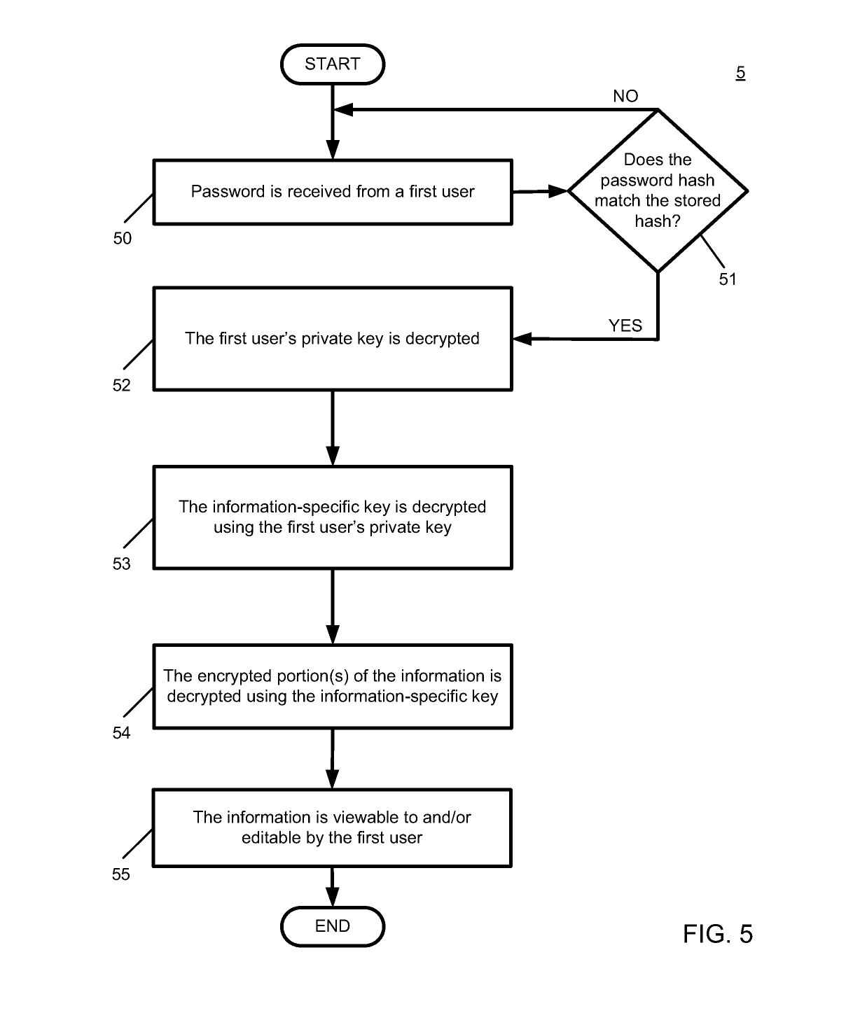

Referring now to FIG. 5, a method of accessing information according to various embodiments is implemented by a computer system 2 according to a process 5. In step 50, a user may provide a password. For example, the user may provide a password when logging in to a user account. In step 51, a hash may be taken over the password and compared to a hash that may be retrieved from storage medium 24. If they do not match, then access may not be granted. In either case, the password may be discarded and not permanently stored.

If the hash over the provided password matches the stored hash, then in step 52, a private key may be decrypted. The private key may be from the key pair of the user that had provided the information to the server 10. If a password was used to encrypt the private key, the password may be used to decrypt the private key. The password used for decrypting may be the password of the user providing the information to the server 10. The password may be discarded and not permanently stored.

In step 53, the unencrypted private key may be used to decrypt the information-specific key. In various embodiments, the unencrypted private key may be the same key that was decrypted in step 52. In some embodiments, a single private key may be used to decrypt multiple information-specific keys. After decrypting the information-specific key, the unencrypted form of the private key may be discarded and not permanently stored.

In step 54, the encrypted portion(s) of the information may be decrypted using the unencrypted information-specific key. In various embodiments, the unencrypted information-specific key may be the same key that was decrypted in step 53. After decrypting the information, the unencrypted form of the information-specific key may be discarded and not permanently stored.

In step 55, the unencrypted information may be accessible to the requesting user(s). For example, the unencrypted form of the information may be viewable, editable, deletable, or the like. The requesting user may have limited access to the information, such as limitations related to creating related gems, reading the specified gem (or related gems), updating the specified gem (or related gems), deleting the specified gem (or related gems), or sharing the specified gem (or related gems).

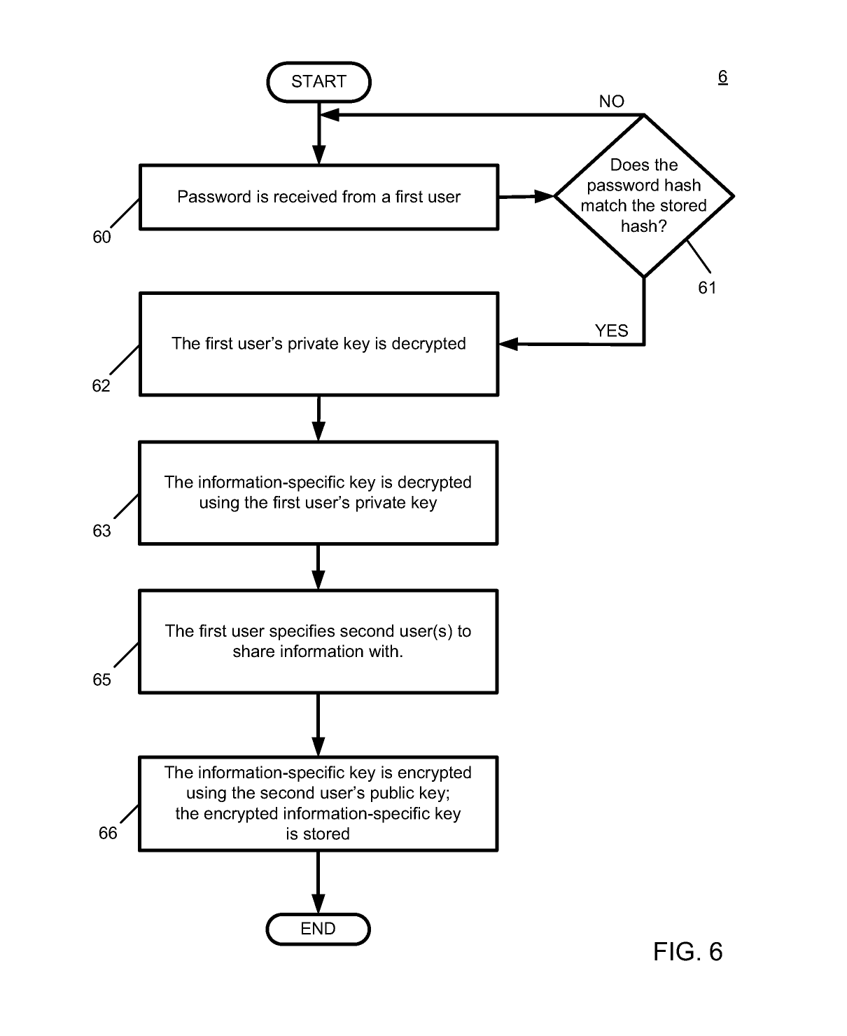

Referring now to FIG. 6, a method of providing access to encrypted information to another user, according to various embodiments, is implemented by a computer system 2 according to a process 6. Steps 60, 61, 62, and 63 of process 6 may be the same as steps 50, 51, 52, and 53, respectively, of process 5 in FIG. 5. Step 66 may be similar to step 46 of process 4 in FIG. 4, except that step 46 refers to encryption using the public key of the (first) user that submitted the information, while step 66 refers to encryption using the public key of a different (second) user, one that has been granted access by another user.

Still referring to FIG. 6, in step 65, the first user may specify one or more users to with which to share information. According to some embodiments, one or more users may be specified by providing uniquely identifying information, such as a unique user name or email address. A first user may specify one or more users to share with by granting a request for sharing information. In some embodiments, step 66 is carried out for each user specified.

The first user may limit access to the information to at least one of creating related gems, reading the specified gem (or related gems), updating the specified gem (or related gems), deleting the specified gem (or related gems), and sharing the specified gem (or related gems). Access may be limited for all users specified in step 65, some of those users, one of those users, or none of those users.

In step 66, the information-specific key may be encrypted using a public key. The public key may be from the key pair of the second user. The encrypted information-specific key and/or the public key may be stored in a storage medium 24. The encrypted information-specific key may be stored within the metadata of one or more corresponding gems. If more than one user was specified in step 65, multiple encrypted information keys may be stored. That is, the same information-specific key may be stored multiple times, except that each one may be encrypted using a different public key. The public key may be stored in unencrypted form. The unencrypted form of the information-specific key may be discarded and not permanently stored.

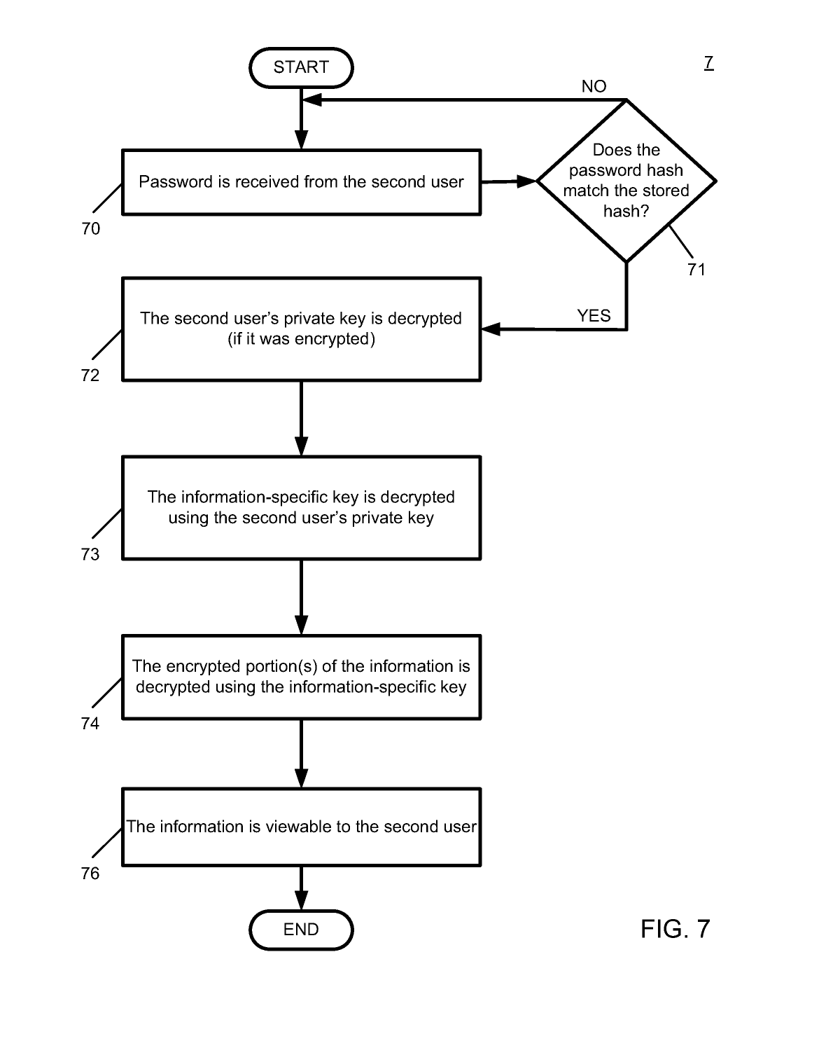

Referring now to FIG. 7, a method of providing information to a second user such that the access was granted by a first user, according to various embodiments, is implemented by a computer system 2 according to a process 7. Steps 70, 71, 72, 73, and 74 of process 7 are similar to steps 50, 51, 52, 53, and 54, respectively, of process 5 in FIG. 5, except that process 5 refers to access by the user that submitted the information, and process 7 refers to access by a different (second) user, one that has been granted access by another user. Additionally, in process 7, the second user's password and private key may be in use, while in process 5, the first user's password and private key may be in use.

Specifically, referring again to FIG. 7, in step 70, a password may be received from the second user. In step 71, if the hash of the provided password does not match the stored hash, the second user may not be granted access.

However, if the hash of the password does match the stored hash, then in step 72, a private key may be decrypted, if it is available in encrypted, but not decrypted, form. The private key may be from the key pair of the second user. If a password was used to encrypt the private key, the password may be used to decrypt the private key. The password used for decrypting may be the password of the second user.

In step 73, the unencrypted private key may be used to decrypt the information-specific key. In various embodiments, the unencrypted private key may be the same key that was decrypted in step 72.

In step 74, the encrypted portion(s) of the information may be decrypted using the unencrypted information-specific key. In various embodiments, the unencrypted information-specific key may be the same key that was decrypted in step 73.

In step 76, the unencrypted information may be accessible to the requesting user(s). In some embodiments, the unencrypted form of the information may be viewable, but not editable, deletable, or the like. In other embodiments, the unencrypted form of the information may have permission to perform one or more of: viewing, but not editing, deleting, sharing with one or more other users, or the like.

According to some embodiments, a gem may be linked to one or more other gems. For example, a field in a first gem may include a reference to a second gem. If a user has access to the first gem, the user may also need access to the second gem to be able to follow the link to the second gem. That is, access to the second gem may not be granted automatically based on access to the first gem.

In some embodiments, access may be revoked. A user may request that a user's access be revoked, a system administrator may revoke access, or the like. Access may be revoked by removing or deleting the information-specific key that is encrypted with the revoked user's public key. Thus, that user will be unable to unencrypt the encrypted gem information.

After various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, a server computer, a cloud-based computing environment, a tablet computer, etc. Additionally, a computer may be embedded in a device not generally regarded as a computer but with suitable processing capabilities, including a Personal Digital Assistant (PDA), a smart phone, or any other suitable portable or fixed electronic device.

Various embodiments may include hardware devices, as well as program products comprising computer-readable, non-transient storage media for carrying or having data or data structures stored thereon for carrying out processes as described herein. Such non-transient media may be any available media that can be accessed by a general-purpose or special-purpose computer or server. By way of example, such non-transient storage media may comprise random-access memory (RAM), read-only memory (ROM), erasable programmable read-only memory (EPROM), electrically erasable programmable read-only memory (EEPROM), field programmable gate array (FPGA), flash memory, compact disk, or other optical disk storage, magnetic disk storage or other magnetic storage devices, or any other medium which can be used to carry or store desired program code in the form of computer-executable instructions or data structures and which can be accessed by a general-purpose or special-purpose computer. Combinations of the above may also be included within the scope of non-transient media. Volatile computer memory, non-volatile computer memory, and combinations of volatile and non-volatile computer memory may also be included within the scope of non-transient storage media. Computer-executable instructions may comprise, for example, instructions and data that cause a general-purpose computer, special-purpose computer, or special-purpose processing device to perform a certain function or group of functions.

In addition to a system, various embodiments are described in the general context of methods and/or processes, which may be implemented in some embodiments by a program product including computer-executable instructions, such as program code. These instructions may be executed by computers in networked environments. The terms “method” and “process” are synonymous unless otherwise noted. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments may encompass many types of computer system configurations, including personal computers, hand-held devices, multiprocessor systems, microprocessor-based or programmable consumer electronics, network personal computers, minicomputers, mainframe computers, and the like.

In some embodiments, the method(s) and/or system(s) discussed throughout may be operated in distributed computing environments in which tasks are performed by local and remote processing devices that may be linked (such as by hardwired links, wireless links, or by a combination of hardwired or wireless links) through a communications network. In a distributed computing environment, according to some embodiments, program modules may be located in both local and remote memory storage devices. Data may be stored either in repositories and synchronized with a central warehouse optimized for queries and/or for reporting, or stored centrally in a database (e.g., dual use database) and/or the like. Databases may include, but are not limited to, highly distributed databases such as those implemented with Apache HBase. Application frameworks that may interface with the database may include, but are not limited to, Ruby on Rails.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. The computer-executable code may include code from any suitable computer programming or scripting language or may be compiled from any suitable computer-programming language, such as, but not limited to, ActionScript, C, C++, C#, Go, HTML, Java, JavaScript, JavaScript Flash, JSON, Objective-C, Perl, PHP, Python, Ruby, Visual Basic, and XML.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that, when executed, perform methods of the present invention, need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

Although the foregoing is described in reference to specific embodiments, it is not intended to be limiting or disclaim subject matter. Rather, the invention as described herein is defined by the following claims, and any that may be added through additional applications or other proceedings. The inventors intend no disclaimer or other limitation of rights by the foregoing technical disclosure.

1. A method of securely storing information, comprising:
encrypting, by one or more computers, at least part of the information using an information-specific key or a key symmetric to the information-specific key;
encrypting, by the one or more computers, the information-specific key using a first public key;
encrypting, by the one or more computers, a first private key associated with the first public key; and
storing, by the one or more computers, in memory the encrypted information, the encrypted first private key, and the encrypted information-specific key.

2. The method of claim 1, further comprising:
decrypting, by the one or more computers, the first private key;
decrypting, by the one or more computers, the information-specific key using the first private key; and
decrypting, by the one or more computers, at least part of the information using the information-specific key.

3. The method of claim 1, further comprising:
verifying, by the one or more computers, that a hash of a password matches a stored password hash.

4. The method of claim 1, further comprising:
decrypting, by the one or more computers, the first private key;
decrypting, by the one or more computers, the information-specific key using the first private key; and
encrypting, by the one or more computers, the information-specific key using a second public key.

5. The method of claim 4, further comprising:
decrypting, by the one or more computers, the information-specific key using a second private key; and
decrypting, by the one or more computers, at least part of the information using the information-specific key.

6. The method of claim 1, further comprising:
verifying, by the one or more computers, permission to access information.

7. The method of claim 1, further comprising:
limiting access, by the one or more computers, to the information to at least one of creating, reading, updating, deleting, or sharing.

8. The method of claim 1, wherein the step of encrypting the first private key is performed using a user password.

9. The method of claim 8, wherein the step of encrypting the first private key is performed using a user password, and wherein the method further comprises decrypting the second private key using a second user password.

10. The method of claim 1, wherein the information, the first private key, and the information-specific key are only transitorily stored in unencrypted form.

11. The method of claim 8, wherein the user password is not permanently stored.

12. A computer system for providing secure access to information, comprising:
memory hardware storing program instructions, and one or more processors in data communication with the memory hardware and configured to execute the program instructions, and upon execution the program instructions causing the one or more processors to perform operations comprising:
encrypting, by the one or more processors, at least part of the information using an information-specific key or a key symmetric to the information-specific key;
encrypting, by the one or more processors, the information-specific key using a first public key;
encrypting, by the one or more processors, a first private key; and
storing, by the one or more processors, in memory the encrypted information, encrypted first private key, and the encrypted information-specific key.

13. The computer system of claim 12, the operations further comprising:
decrypting, by the one or more processors, the first private key;
decrypting, by the one or more processors, the information-specific key using the first private key; and
decrypting, by the one or more processors, at least part of the information using the information-specific key.

14. The computer system of claim 12, the operations further comprising:
verifying, by the one or more processors, that a hash of a password matches a stored password hash.

15. The computer system of claim 12, the operations further comprising:
decrypting, by the one or more processors, the first private key;
decrypting, by the one or more processors, the information-specific key using the first private key; and
encrypting, by the one or more processors, the information-specific key using a second public key.

16. The computer system of claim 15, the operations further comprising:
decrypting, by the one or more processors, the information-specific key using a second private key; and
decrypting, by the one or more processors, at least part of the information using the information-specific key.

17. The computer system of claim 12, the operations further comprising:
verifying, by the one or more processors, permission to access information.

18. The computer system of claim 12, the operations further comprising:
limiting access, by the one or more processors, to the information to at least one of creating, reading, updating, deleting, or sharing.

19. (canceled)

20. The system of claim 16, wherein the operation of encrypting the first private key is performed using a user password, and wherein the operations further comprise decrypting the second private key using a second user password.

21. The system of claim 12, wherein the information, the first private key and the information-specific key are only transitorily stored in unencrypted form.

22. (canceled)

23. A non-transitory tangible computer-readable storage medium having instructions encoded thereon, wherein the instructions when processed by one or more computers perform the following operations:
encrypting, by the one or more computers, at least part of the information using an information-specific key or a key symmetric to the information-specific key;
encrypting, by the one or more computers, the information-specific key using a first public key;
encrypting, by the one or more computers, a first private key associated with the first public key; and
storing, by the one or more computers, in memory the encrypted information, encrypted first private key, and the encrypted information-specific key.

24. The tangible computer-readable storage medium of claim 23, the operations further comprising:
decrypting, by the one or more computers, the first private key;
decrypting, by the one or more computers, the information-specific key using the first private key; and
decrypting, by the one or more computers, at least part of the information using the information-specific key.

25. (canceled)

26. The tangible computer-readable storage medium of claim 23, the operations further comprising:
decrypting, by the one or more computers, the first private key;
decrypting, by the one or more computers, the information-specific key using the first private key; and
encrypting, by the one or more computers, the information-specific key using a second public key.

27-33. (canceled)
